(19) United States
(12) Patent Application Publication
(10) Pub. No.: US 2006/0076356 A1
(43) Pub. Date: Apr. 13, 2006

(54) Composite vessel construction for cosmetic products

(76) Inventor: Giovanni Bocola, Milano (IT)

Correspondence Address: HEDMAN & COSTIGAN P.C., 1185 AVENUE OF THE AMERICAS, NEW YORK, NY, 10036, US

(21) Appl. No.: 10/530,312

(22) PCT Filed: Oct. 8, 2003
(86) PCT No.: PCT/IT03/00606

§ 371 Date: Apr. 4, 2005

(30) Foreign Application Priority Data
Oct. 10, 2002 (IT) MI2002A 002154

(51) Int. Cl. B28B 5/00; B65D 43/14; B65D 6/28

(52) U.S. Cl. 220/839; 264/250; 220/780; 220/4.23

(57) ABSTRACT

A composite vessel construction (1), specifically designed for cosmetic products, characterized in that it comprises an inner body (2), adapted to form the vessel body, and an outer body (3), having a configuration different from that of the inner body (2), the inner (2) and outer (3) bodies being embedded into one another during the molding of the construction (1). The outer body (3) is applied to the inner body (2) by co-molding.

### BACKGROUND OF THE INVENTION

The present invention relates to a composite vessel construction, specifically designed for cosmetic products.

As is known, in making vessels for cosmetic and the like products, it is necessary to provide the vessel both with good operating properties and good aesthetic characteristics.

Usually, the vessels for the above mentioned applications are made of polyethylene, which material provides the vessel with the required mechanical strength and chemical resistance characteristics, however, this material severely limits the possibilities of “stylizing” the vessel with respect to its finished outer aspect.

### SUMMARY OF THE INVENTION

Accordingly, the aim of the present invention is to provide such a vessel construction which, while having very good operating features, is also provided with very good aesthetic characteristics.

Within the scope of the above mentioned aim, a main object of the invention is to provide such a composite vessel construction, which can be made in a large series, and at a very competitive cost, with respect to prior like vessels.

Yet another object of the present invention is to provide such a composite vessel construction the outer configuration of which can be easily changed.

Yet another object of the present invention is to provide such a vessel construction the aesthetic requirements of which are not bound to the merely functional requirements thereof, such as the mechanical strength and its compatibility with the products to be held therein.

According to one aspect of the present invention, the above mentioned aim and objects, as well as yet other objects, which will become more apparent hereinafter, are achieved by a composite vessel construction, specifically designed for cosmetic products, characterized in that said composite vessel construction comprises an inner body, adapted to form the vessel body, and an outer body, having a configuration different from that of the inner body, said inner body and said outer body being embedded into one another during the molding of the composite vessel construction.

### BRIEF DESCRIPTION OF THE DRAWINGS

Further characteristics and advantages of the present invention will become more apparent hereinafter from the following detailed disclosure of a preferred, though not exclusive embodiment of the invention, which is illustrated, by way of an indicative, but not limitative, example, in the accompanying drawings, where:

FIG. 1 is a perspective view of the composite vessel construction according to the present invention, being shown in an open position thereof;

FIG. 2 is a further perspective view of the inner body of the composite vessel construction, according to the invention, being shown in an open position thereof;

FIG. 3 is a further perspective view, on an enlarged scale, of the cover and main body of the inner body of the composite vessel construction according to the invention;

FIG. 4 is a view similar to FIG. 3, which illustrates the hinge assembly of the cover, formed by the inner body;

FIG. 5 is a further perspective view, further enlarged with respect to the preceding figures, of the hinge assembly, which is formed, in this embodiment, by the outer body;

FIG. 6 is a further enlarged perspective view illustrating the hinge assembly of the composite vessel construction according to the invention, being shown in a closed position and as partially broken away;

FIG. 7 is an elevation, longitudinal cross-section, view of the composite vessel construction according to the present invention; and

FIG. 8 is an enlarged cross-sectional view of the closure region of the cover.

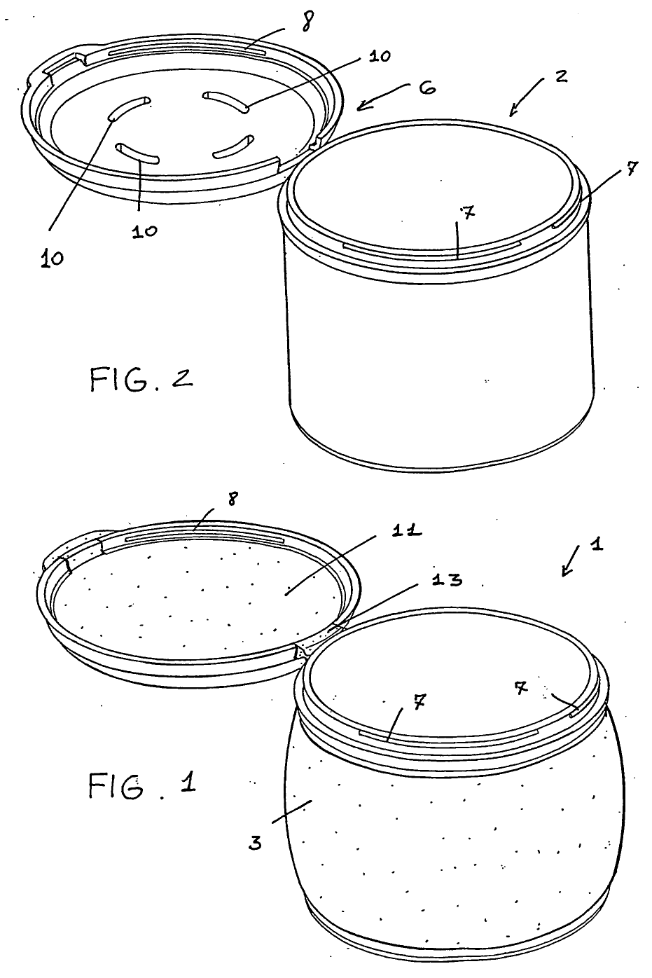

### DESCRIPTION OF THE PREFERRED EMBODIMENT

With reference to the number references of the above mentioned figures, the composite vessel construction, according to the present invention, which has been generally indicated by the reference number 1, comprises an inner body 2, embedded in an outer body comprising at least a main outer portion 3 and at least an outer cover portion 4.

More specifically, the inner body 2 comprises a main portion 5, for example of a substantially cylindrical configuration, as in the shown embodiment, and a cover 6, designed for closing the main portion so as to provide the vessel body proper.

Advantageously, the mentioned inner body can be made of a strong material, such as a polypropylene material.

The top outer edge of the main portion 5 comprises an outer annular ridge 7, which must not be necessarily continuous, as shown in the figures, adapted to engage with an inner annular ridge 8, formed on an inner surface of the cover 6, to provide a snap and tight type of closure of the cover.

The main portion 5 of the inner body 2 can have, as in the shown embodiment, a bottom element 9, raised with respect to the bottom edge of the main portion 5.

According to the present invention, to the inner body 2 is applied, for example by co-molding, the mentioned outer body.

The latter comprises a substantially cylindrical outer crowned portion 3, encompassing the side surface of the main portion 5, which is also of substantially cylindrical configuration, and an outer ortion 4, applied to the top surface of the cover 6.

The cover 6 of the inner body 2 is advantageously provided with holes 10 for allowing the outer body forming material to penetrate therethrough, said outer body thereby also forming an inner portion 11 of the cover 6.

The inner portion 11 of the outer body provides, therefore, an exposed to the view surface, as the vessel construction is in an open condition thereof, and, moreover, it can cooperate to provide the sealing coupling, as the vessel construction is closed, as is shown in FIG. 7, with the top edge portion of the main portion 5 of the inner body 2.

Advantageously, the outer body is made of a rubber-like material, having aesthetic characteristics better than those of polypropylene, and also adapted to provide a good touch feeling.

The cover is coupled to the vessel body through a hinge assembly, which can be made by molding in a single piece with the inner body 2, or in a single piece with the outer body.

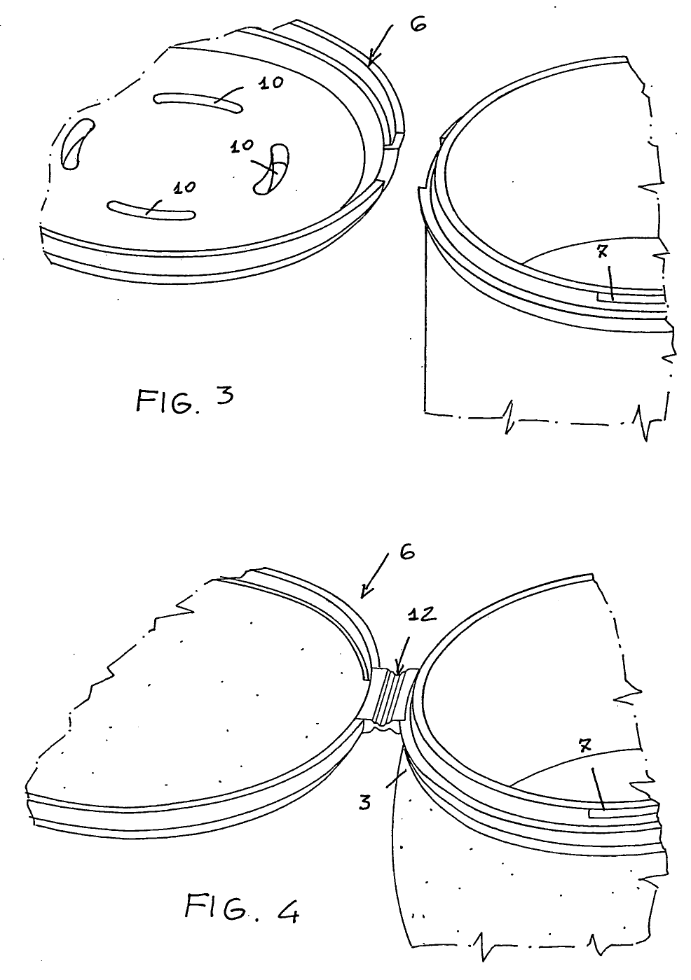

FIG. 4 illustrates a hinge assembly 12 formed as a single piece with the inner body 2 and coupling the main portion 5 to the cover 6.

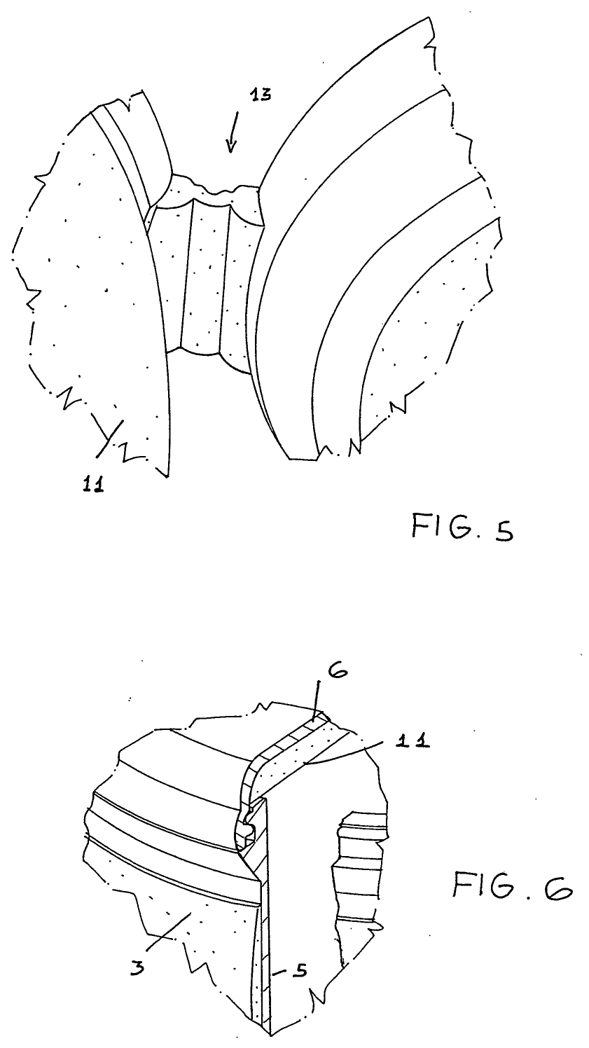

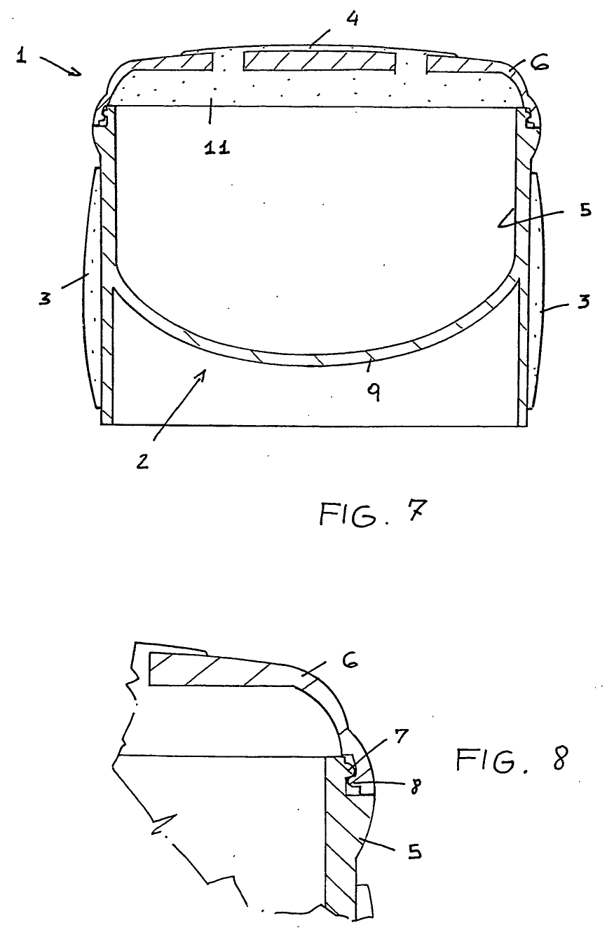

FIGS. 1 and 5 show, as a modified embodiment, a hinge assembly 13 formed as a single piece with the outer body and designed for connecting the substantially cylindrical outer crowned portion 3 with the inner portion 11 formed inside the cover 6.

In this connection it should be pointed out that the hinge assembly exploits the elasticity of the material and comprises suitable cut-outs or lightened portions to favor the vessel opening and closing movements, without excessively stress the vessel material, thereby providing a sufficient number of opening and closing cycles.

It has been found that the invention fully achieves the intended aim and objects.

In fact, the invention has provided a composite vessel construction which is very functional from a mere operating standpoint while being provided with very good aesthetic characteristics.

While the inner body can be made in a substantially conventional configuration, for example in a cylindrical configuration, the outer body can be so contoured as to present a particular aesthetic aspect.

That same inner body, in particular, can be used for making different vessel constructions, each characterized by a different outer body, having different configurations and colors.

In practicing the invention, the used materials, as well as the contingent size and shapes, can be any, depending on requirements and the status of the art.

1. A composite vessel construction, specifically designed for cosmetic products, characterized in that said composite vessel construction comprises an inner body, adapted to form the vessel body, and an outer body, having a configuration different from that of the inner body, said inner body and said outer body being embedded into one another during the molding of the composite vessel construction.

2. A vessel construction, according to claim 1, characterized in that said inner body comprises a main portion and a cover, adapted to close said main portion, thereby providing a vessel body proper.

3. A vessel construction, according to claim 1 or 2, characterized in that said inner body is made of polypropylene and said outer body is made of a rubber material.

4. A vessel construction, according to one or more of the preceding claims, characterized in that said main portion has a top outer edge portion comprising an annular outer ridge adapted to engage with an annular inner ridge formed on an inner surface of said cover, to provide a snap and tight closure of said cover.

5. A vessel construction, according to one or more of the preceding claims, characterized in that said main portion of said inner body comprises a bottom element, raised from the bottom edge of the main portion

6. A vessel construction, according to one or more of the preceding claims, characterized in that said outer body is applied to said inner body by co-molding, said outer body comprising a substantially cylindrical outer crowned portion encompassing the side surface of the main portion, which is of substantially cylindrical configuration, and an outer portion applied to the top surface of said cover.

7. A vessel construction, according to one or more of the preceding claims, characterized in that said cover of said inner body comprises a plurality of holes adapted to allow the material forming said outer body to penetrate thereinto, said outer body also forming an inner portion inside said cover.

8. A vessel construction, according to one or more of the preceding claims, characterized in that said inner portion of said outer body provides an exposed to the view surface, as the vessel construction is in an open condition thereof, and which, moreover, cooperates to provide the sealing of said vessel as said vessel is closed, with the top edge of the main portion of the inner body.

9. A vessel construction, according to one or more of the preceding claims, characterized in that said cover is coupled to said vessel body by a hinge assembly which is made by molding as a single piece with said inner body or as a single piece with said outer body.

10. A vessel construction, according to one or more of the preceding claims, characterized in that said hinge assembly is made as a single piece with said inner body and connects said main portion to said cover.

11. A vessel construction, according to one or more of the preceding claims, characterized in that said hinge assembly is made as a single piece with said outer body and connects said substantially cylindrical outer crowned portion to said inner portion formed inside said cover.

12. A vessel construction, according to one or more of the preceding claims, characterized in that said vessel construction comprises one or more of the disclosed and/or illustrated features.
